(19) United States
(12) Patent Application Publication
(10) Pub. No.: US 2010/0250007 A1
(43) Pub. Date: Sep. 30, 2010

(54) REFRIGERATION SYSTEM

(75) Inventor: Keith W. Ballantyne, York, PA (US)

Correspondence Address: MCNEES WALLACE & NURICK LLC, 100 PINE STREET, P.O. BOX 1166, HARRISBURG, PA, 17108-1166, US

(73) Assignee: JOHNSON CONTROLS TECHNOLOGY COMPANY, Holland, MI (US)

(21) Appl. No.: 12/598,763

(22) PCT Filed: May 8, 2008
(86) PCT No.: PCT/US2008/063054

§ 371 Date: Nov. 4, 2009

Related U.S. Application Data
(60) Provisional application No. 60/916,875, filed on May 9, 2007.

(51) Int. Cl. G05D 23/19; G05B 19/045; G06F 9/45; G06F 12/14; G06F 9/24

(52) U.S. Cl. 700/276; 700/86; 713/190; 700/7; 713/2; 717/140

(57) ABSTRACT

A method or system for executing a control logic sequence for a device (chiller) includes using a device mounted internal microprocessor in data communication with the device, converting a software language representation of the control logic directly into a binary representation of the control logic; compiling the binary representation of the control logic directly by the device mounted internal microprocessor; loading the binary representation of the control logic dynamically into a random access memory portion of the internal microprocessor; and executing the binary formatted representation of the control logic to control the device according to the software language representation of the control logic.

### CROSS-REFERENCES TO RELATED APPLICATIONS

This application claims the priority of and the benefit of U.S. Provisional Application No. 60/916,875, entitled METHOD AND SYSTEM FOR COMPILING LOGIC CONTROL INSTRUCTIONS ON A DEVICE CONTROL UNIT, filed May 9, 2007, which is hereby incorporated by reference.

### BACKGROUND

The application generally relates to a method and system for executing programmable logic controls, and more specifically to a method and system of executing control logic in a heating, ventilation, air conditioning and refrigeration (HVAC&R) system.

Commercial, industrial and residential buildings may include HVAC&R systems to control the interior environment of the building. For example, an HVAC&R system may operate as a chiller or refrigeration system having at least one compressor, that operates in conjunction with condensers, evaporators, fans, and other refrigeration circuit components to dehumidify and cool the air circulating throughout the interior of the building. Each component of the HVAC&R system may include an electronic control panel that permits an operator to activate, deactivate, or adjust the speed or other operating parameter of the component. The electronic control panel may be mounted directly on the equipment, but may be placed in proximity to the equipment at a location more easily accessible to the operator.

The chiller system is operated by control logic, which may be provided in the form of a programmable logic controller (PLC). The PLC may provide sequential control instructions and input/output (I/O) to a microprocessor-based electronic controller of a chiller system. Computer instructions may be created in a high level programming language suitable for PLCs, for example, C++. Ladder logic programs may be thus developed to implement ladder diagram electrical schematics electronically instead of through hardwired relay circuits. Ladder logic may be used to program PLCs if a sequential control of a process or manufacturing operation is required, for example, in a chiller system.

Control logic and its representation in higher level languages, such as Ladder Diagrams, Functional Block Diagrams, and Structured Text, is defined in several industry standards, such as the IEC 61131 series of specifications. A programmable logic controller interprets these control logic representations and programmatically responds to inputs and outputs within a system. This process may be accomplished in various ways. In some control schemes, a programmable logic controller may execute an interpreter, which may interpret the code from the control logic representation or diagram, and may respond according to the code that is interpreted. In the interpreter and response control schemes, the responsiveness of the control system may be limited by the cycle time. The logic controller may run in a ‘loop’ or cycle at a predetermined frequency, so that changes in state or inputs/outputs may only be acknowledged in the next time interval as defined by the loop. Some systems may operate with loop cycles that are measured in seconds, while other system loop cycles are measured in milliseconds or other time intervals. The loop cycle time may depend on the clock speed of the underlying central processing unit (CPU), resulting in a fixed speed limitation for processing inputs and outputs.

In another form of control scheme, a host platform such as a personal computer (PC) may be used to convert the high level representation of the control logic representation. The representation may be downloaded onto the PLC. The host platform control scheme may use a set of external tools to convert the logic into a format for the PLC, which may be an intermediate format, or in a format of native instructions that are understood by the PLC. The external tools may not be co-located with the equipment that is being controlled.

The interpreter and response and host platform control schemes are referred to as code interpreters. Interpreting code may be slower than running compiled code because the interpreter must analyze each statement in the program each time it is executed and then perform the desired action. The compiled code performs the action as instructed as a run-time analysis called “interpretive overhead”. For example, the approach may embed a logic engine into the control electronics in the form of software executing on a CPU. Such control engines implement an interpreted environment, where control logic is loaded and interpreted by the engine. Implementations relying on interpretation may suffer a performance penalty. Programmable logic solutions may incur a significant royalty cost per unit, and rely on precompiled algorithms in the form of libraries. Another existing alternative is to use a front end tool that generates native code, such as Simulink®. The alternative front end tool enables the development of logic, and directly generates code that is subsequently compiled for the platform on which the code is executed. Tools such as Simulink® are prohibitively expensive to be cost effectively deployed throughout a large number of field installations. While Simulink® generated code suffers from fewer performance penalties than the first control scheme outlined above, the programming language provided used by Simulink® is typically unfamiliar to automation controls engineers. The internal representation of the logic may not be reasonably converted into code directly by the unit.

### SUMMARY

One embodiment of the present invention relates to a method of executing a software language representation of a control logic sequence for a device (chiller) which includes using a device mounted internal microprocessor in data communication with the device, converting the software language representation of the control logic directly into a binary representation of the control logic sequence; compiling the binary representation of the control logic sequence directly by the device mounted internal microprocessor; loading the binary representation of the control logic sequence dynamically into a random access memory portion of the internal microprocessor; and executing the binary formatted representation of the control logic sequence to control the device according to the software language representation of the control logic sequence.

Another embodiment of the present invention relates to a system for executing a software language representation of a control logic sequence for a machine. The system includes a control logic panel having an internal microprocessor mounted on the machine. The microprocessor is in data communication with the machine. The control logic panel includes an abstract operating environment having a user interface, an operating system and an engine. The abstract operating environment is configured to convert the software language representation of the control logic sequence directly into a binary representation of the control logic sequence; directly compile the binary representation of the control logic sequence directly by the device mounted internal microprocessor; load the binary representation of the control logic sequence dynamically into a memory portion of the internal microprocessor; and execute the binary formatted representation of the control logic to control the device according to the software language representation of the control logic sequence.

Another embodiment of the present invention relates to a chiller system including a compressor, a condenser, and an evaporator connected in a closed refrigerant circuit. The compressor includes a control logic panel having an internal microprocessor mounted on the chiller system. The microprocessor is in data communication with the chiller system. The microprocessor is configured to convert a software language representation of a control logic sequence directly into a binary representation of the control logic sequence. The microprocessor also directly compiles the binary representation of the control logic sequence by the chiller mounted internal microprocessor, and loads the binary representation of the control logic sequence dynamically into a random access memory portion of the internal microprocessor. Finally, the microprocessor is also configured to execute the binary formatted representation of the control logic sequence to control the chiller system according to the software language representation of the control logic sequence.

### BRIEF DESCRIPTION OF THE FIGURES

FIG. 1 shows an exemplary embodiment of a Heating, Ventilation, Air Conditioning and Refrigeration (HVAC&R) system in a commercial environment.

FIG. 2 shows an exemplary embodiment of a compressor unit of a Heating, Ventilation, Air Conditioning and Refrigeration (HVAC&R) system.

FIG. 3 schematically illustrates a Heating, Ventilation, Air Conditioning and Refrigeration (HVAC&R) system that may be used in FIG. 1 and may employ the present invention.

FIG. 4 schematically illustrates a system architecture for an operating environment for processing control logic in an exemplary control system.

FIG. 5 schematically illustrates an exemplary control system.

FIGS. 6, 7, 8, and 9 are fragmentary schematic views that taken together illustrate an embodiment of a control system of the present invention.

FIG. 10 shows a flowchart illustrating a method of using an exemplary embodiment of the control system of the present invention.

### DETAILED DESCRIPTION OF THE EXEMPLARY EMBODIMENTS

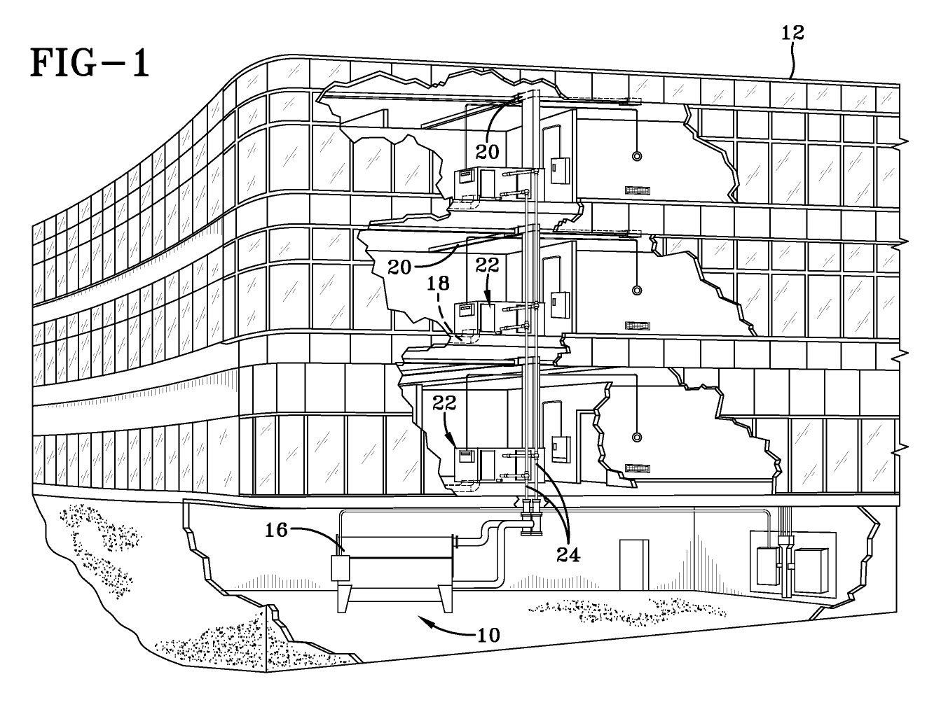

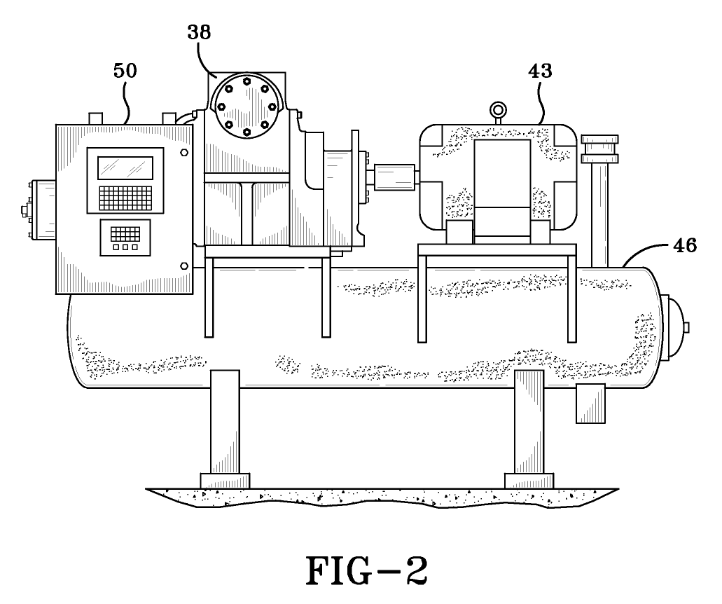

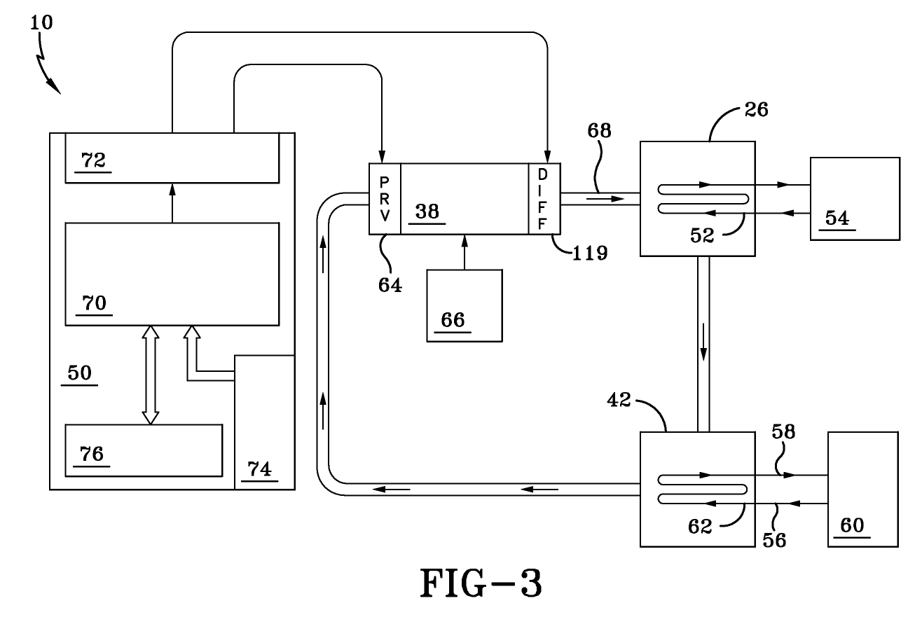

Referring to FIGS. 1 and 3, an exemplary environment for a Heating, Ventilating, Air Conditioning system (HVAC system) 10 in a building 12 for a typical commercial setting is shown. System 10 may include a compressor (not shown) incorporated into a chiller 16 that can supply a chilled liquid that may be used to cool building 12. In one embodiment the compressor 40 may be a screw compressor 40 (see for example, FIG. 2). In other embodiments the compressor 40 may be a centrifugal compressor or reciprocal compressor (not shown). System 10 includes an air distribution system that circulates air through building 12. The air distribution system can include an air return duct 18, an air supply duct 20 and an air handler 22. Air handler 22 can include a heat exchanger (not shown) that is connected to a boiler (not shown) and chiller 16 by conduits 24. The air handler 22 may receive either heated liquid from the boiler or chilled liquid from chiller 16 depending on the mode of operation of HVAC system 10. HVAC system 10 is shown with a separate air handler 22 on each floor of building 12, but it will be appreciated that these components may be shared between or among floors.

FIG. 2 shows an exemplary embodiment of a screw compressor 40 in a packaged unit for use with chiller 16. The packaged unit includes screw compressor 40, a motor 43 to drive screw compressor 40, and a control panel 50 to provide control instructions to equipment included in the packaged unit, such as motor 43. An oil separator 46 can be provided to remove entrained oil (used to lubricate the rotors of screw compressor 40) from the discharge vapor before providing the discharge vapor to its intended application.

FIG. 3 shows an exemplary HVAC&R or liquid chiller system 10, which includes compressor 38, condenser 26, water chiller or evaporator 42, and a control panel 50. Control panel 50 may include a microprocessor 70, an interface board 72, an A to D converter 74, and/or a non-volatile memory 76. Control panel 50 may be positioned or disposed locally and/or remotely to system 10. Control panel 50 receives input signals from system 10, for example, temperature and pressure measurements indicating the performance of system 10. The signals are transmitted to components of system 10, for example, a compressor capacity control signal, to control the operation of system 10. Conventional liquid chiller or HVAC&R system 10 may include other features that are not shown in FIG. 3. These features have been purposely omitted to simplify the drawing for ease of illustration. While the following description of system 10 is in terms of a liquid chiller system, it is to be understood that the invention could be applied to any refrigeration system or any HVAC&R system.

Compressor 38 compresses a refrigerant vapor and delivers the vapor to condenser 26 through a discharge line 68. In one embodiment, compressor 38 is a screw compressor; however, compressor 38 may be any suitable type of compressor including centrifugal compressor, reciprocating compressor, scroll compressor, rotary compressor or other type of compressor. System 10 may have more than one compressor 38 connected in one or more refrigerant circuits.

Refrigerant vapor delivered to condenser 26 enters into a heat exchange relationship with a fluid, for example, air or water, and undergoes a phase change to a refrigerant liquid as a result of the heat exchange relationship with the fluid. The condensed liquid refrigerant from condenser 26 flows to evaporator 42. Refrigerant vapor in condenser 26 enters into the heat exchange relationship with water, flowing through a heat-exchanger coil 52 connected to a cooling tower 54. The refrigerant vapor in condenser 26 undergoes a phase change to a refrigerant liquid as a result of the heat exchange relationship with the water in heat-exchanger coil 52.

Evaporator 42 may include a heat-exchanger coil 62 having a supply line 56 and a return line 58 connected to a cooling load 60. Heat-exchanger coil 62 can include a plurality of tube bundles within evaporator 42. A secondary liquid, for example, water, ethylene, calcium chloride brine, sodium chloride brine, or any other suitable secondary liquid travels into evaporator 42 via supply line 56 and exits evaporator 42 via return line 58. The liquid refrigerant in evaporator 42 enters into a heat exchange relationship with the secondary liquid in heat-exchanger coil 62 to chill the temperature of the secondary liquid in heat-exchanger coil 62. The refrigerant liquid in evaporator 42 undergoes a phase change to a refrigerant vapor as a result of the heat exchange relationship with the secondary liquid in heat-exchanger coil 62. The vapor refrigerant in evaporator 42 exits evaporator 42 and returns to compressor 38 by a suction line to complete the cycle. While system 10 has been described in terms of condenser 26 and evaporator 42, any suitable configuration of condenser 26 and evaporator 42 can be used in system 10, provided that the appropriate phase change of the refrigerant in condenser 26 and evaporator 42 is obtained. The refrigerant cycle described above is but one example of a refrigerant cycle that may be used, and any number of other refrigerant cycles, such as an absorption refrigerant cycle, may be used.

In one embodiment using a centrifugal compressor 38, at the input or inlet to compressor 38 from evaporator 42, there are one or more pre-rotation vanes or inlet guide vanes 64 that control the flow of refrigerant to compressor 38. An actuator (not shown) is used to open pre-rotation vanes 64 to increase the amount of refrigerant to compressor 38 and thereby increase the cooling capacity of system 10. The actuator is used to close pre-rotation vanes 64 to decrease the amount of refrigerant to compressor 38 and thereby decrease the cooling capacity of system 10. In another embodiment, chiller system capacity may be controlled by adjusting the speed of a compressor motor driving compressor 38, using a variable speed drive (VSD).

To drive compressor 38, system 10 includes a motor or drive mechanism 66 for compressor 38. While the term “motor” is used with respect to the drive mechanism for compressor 38, the term “motor” is not limited to a motor, but may encompass any component that may be used in conjunction with the driving of compressor 38, such as a variable speed drive and a motor starter. Motor or drive mechanism 66 is an electric motor and associated components. Other drive mechanisms, such as steam or gas turbines or engines and associated components, may be used to drive compressor 38.

Control panel 50 executes a control system that uses a control algorithm or multiple control algorithms or software to control operation of system 10 and to determine and implement an operating configuration for the inverters of a VSD (not shown) to control the capacity of compressor 38 or multiple compressors in response to a particular output capacity requirement for system 10. The control algorithm or multiple control algorithms may be computer programs or software stored in non-volatile memory 76 of control panel 50 and may include a series of instructions executable by microprocessor 70. The control algorithm may be embodied in a computer program or multiple computer programs and may be executed by microprocessor 70, and the control algorithm may be implemented and executed using digital and/or analog hardware (not shown). If hardware is used to execute the control algorithm, the corresponding configuration of control panel 50 may be changed to incorporate the necessary components and to remove any components that may no longer be required.

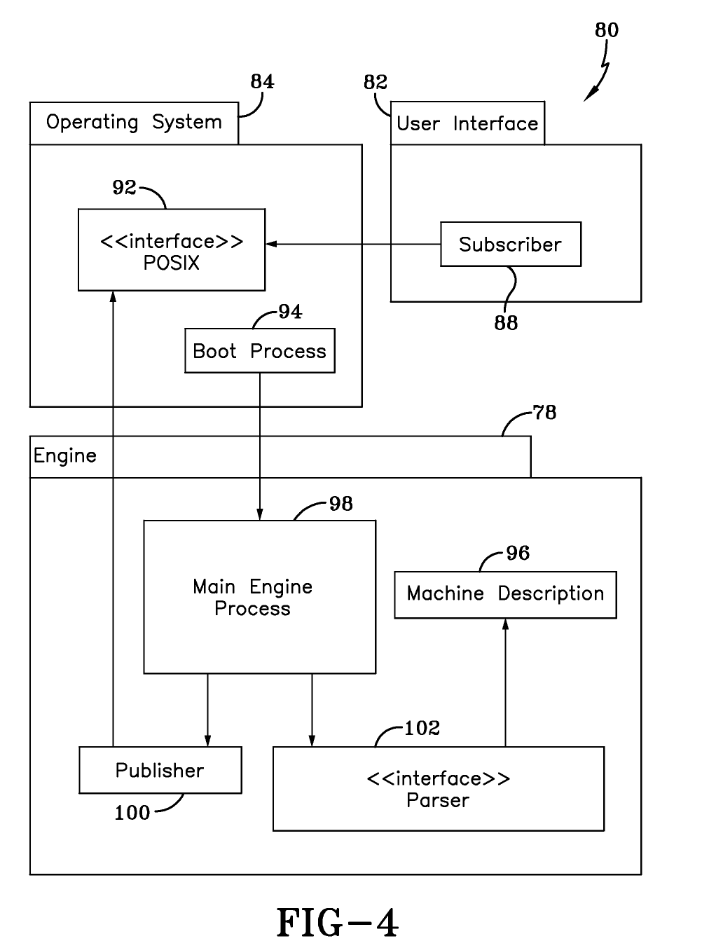

Referring to FIG. 4, an execution engine 78 provides an abstract operating environment for a control system 80. Control system 80 may be implemented in a chiller system as shown in FIGS. 1 through 3, or in alternate embodiments, the control system 80 may be used in association with a variety of machine, process, or other control systems that are operated with programmable logic controllers (PLC). The architecture shown in FIG. 4 schematically illustrates the business logic for a chiller control system or other suitable control system from a compiled environment, and generates a standardized representation which is independent of the machine code that is executed on the platform. This method allows the chiller control logic to be updated without recompiling the environment. Front end tools, such as Graphical Programming Language (GPL) by Johnson Controls Inc., of Milwaukee, Wis., may be used to generate the model that is used within the chiller. Control system 80 includes three main elements: a user interface 82, an operating system (OS) 84 and an engine 78. User interface 82 includes a subscriber 88. OS 84 may be QNX®, Microsoft® Windows®, MS Vista®, Linux®, Mac OS®, Unix®, or other similar operating systems. A subscriber 88 is an abstraction of a client query for a Portable Operating System Interface for uniX (POSIX) interface for published items. POSIX interface 92 is defined by OS 84. A boot process 94 resides in OS 84 as an abstraction of an initial client that runs at boot time to start or invoke engine 78. Boot process 94 provides a file containing a machine description 96 to engine 78. Machine description 96 provides an abstraction of the control logic for a machine, for example, a chiller. Engine 78 also includes a main engine process 98, a publisher 100, and a parser 102, in addition to machine description 96.

Main engine process 98 is responsible for executing the specification of the chiller. Engine 78 is intended to provide an abstract operating environment for a machine. The control logic is abstracted from a compiled environment and into a standardized representation independent of the actual code that executes on the platform. By abstracting the control logic into a standardized representation, the control logic may be updated directly and without recompiling the environment. Graphic control programming language software, for example, JCI GPL by Johnson Controls, Inc., may be employed to generate the model that is executed by the chiller. Main engine process 98 invokes parser 102 using the machine description provided by boot process 94. Parser 102 is an abstraction of a system that is capable of parsing a stream or file representing the control logic definition for the chiller. Parser 102 defines variables, initializes libraries and checks for the presence of a file, finds and returns elements defined within the file, returns the element, and if there is no other element, outputs a message that indicates so. If a current element is valid, parser 102 returns the element data and attributes, and if the current element is invalid, outputs a message indicating that the current element is invalid.

Publisher 100 provides an abstraction of the system that makes visible to other system components information about the state and variables of the system. Publisher 100 initializes libraries and local variables, accepts and validates publishable items, and includes them in a list. POSIX 92 formats data requests from subscriber 88 and proxies the data requests to publisher 100. Through user interface 82, subscriber 88 queries publisher 100 indirectly through POSIX 92, receives or sets published items, and returns results or error messages.

When executing the control logic, no interpretation step is necessary. The CPU executes native instructions that represent the control logic. The tool chain that converts the representation into native binary is co-located on a special purpose control board that is dedicated to the control method.

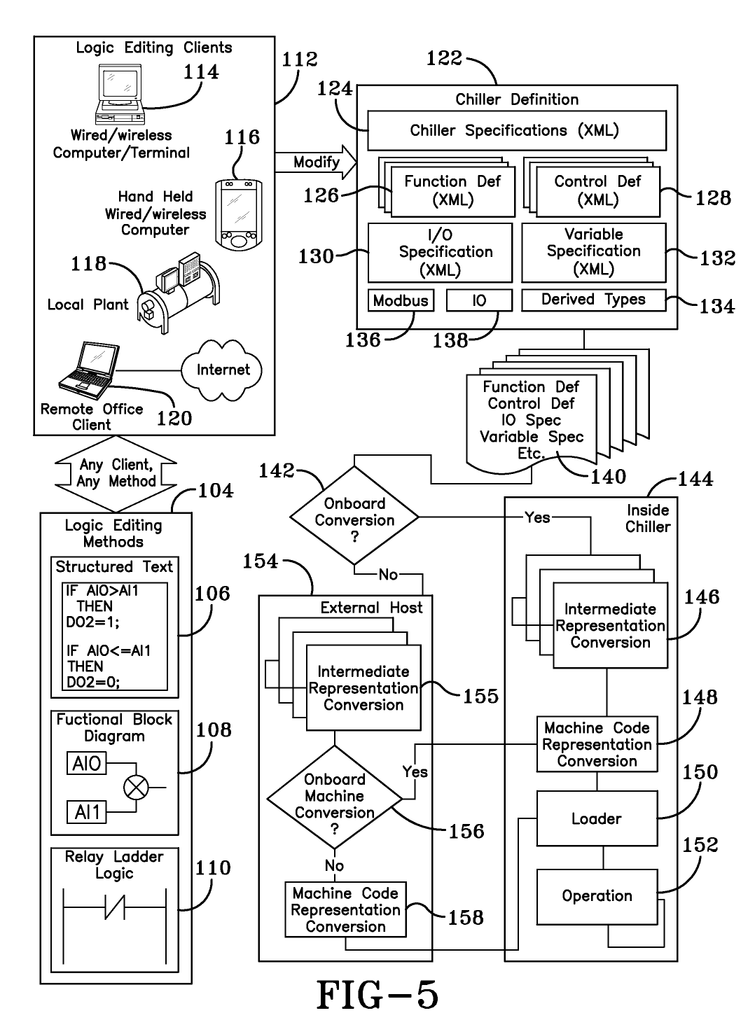

FIG. 5 shows one embodiment of a chiller plant control system for compiling a control logic sequence directly by the internal microprocessor within the control panel of the chiller. Logic editing methods 104 include a variety of visual, graphical or textual tools for configuring the chiller operation. Non-limiting examples of logic editing methods 104 are structured text editors 106, functional block diagramming programs 108, and relay ladder logic representations 110. Such tools provide a view into the chiller system XML data. The tools may be used in developing the control software without requiring modifications to the chiller internal control system. For example, a programmer could update the chiller using a ‘ladder logic tool’, or using functional block diagrams (FBD), or a basic XML editor. The selected tool has no bearing on chiller operation or the resultant code. Other control logic editing methods 104 may be used, as will be appreciated by those persons of skill in the art. Any of the logic editing methods 104 may be installed on and executed by a logic editing client 112. Logic editing clients 112 include a variety of hardware options, any of which are capable of executing logic editing method or methods 104. Examples are a computer (PC) or terminal of a network 114, a handheld computer 116, a local control plant panel 118 of a chiller system component, for example, a compressor, or a remote office client with an Internet connection 120. Logic editing clients 112 may be hard wired or wirelessly coupled in communication with a network shared with chiller system 10 (FIG. 3). Any logic editing clients 112 may be configured to modify chiller definition 122. Chiller definition 122 includes chiller specification 124, a function definition 126, a control definition 128, an input/output (I/O) specification 130 and a variable specification 132. Each chiller specification 124, function definition 126, control definition 128, I/O specification 130 and variable specification 132 is a software language representation of the control logic in a human readable format, for example, XML. In addition, chiller definition 122 may include a Modbus protocol 136, I/O ports 138 and derived types 134. An XML version of chiller control logic 140 is then provided and a decision is made whether control logic 140 is to be converted onboard the chiller, as indicated by logic decision box (onboard conversion) 142. If control logic 140 is programmed for onboard processing, then the XML version specification is forwarded to control panel 144 within the chiller and converted to an intermediate representation of control logic 140 indicated as step 146. Converted intermediate representation 146 is then forwarded to a machine code representation conversion in the onboard processor at step 148 and converted machine code from step 148 is loaded in the chiller microprocessor at a loader step 150 within chiller control panel 144. Chiller control panel 144 microprocessor iteratively executes the machine readable code representation in an operation step 152.

If at a decision box 142, control logic 140 is not programmed for onboard processing, control logic representation 140 is forwarded to an external host computer 154, where it undergoes an intermediate conversion as indicated at step 155. After intermediate representation conversion occurs at step 155, converted control logic representation 140 is forwarded to another decision box 156. If intermediate representation conversion 155 is programmed for onboard processing, it is forwarded for machine code representation conversion in the onboard processor at step 148. From there the machine code representation is processed as set forth above in steps 150 and 152. Otherwise, if intermediate representation conversion 155 is not programmed for onboard processing at steps 156, control logic representation 140 is forwarded for conversion to machine code representation within external host 154 at step 158. Converted machine code from step 158 is loaded in the chiller microprocessor at loader step 150 within chiller control panel 144, and after loading is subsequently processed at operation step 152, as discussed above. The chiller microprocessor iteratively executes the machine readable code representation in operation step 152.

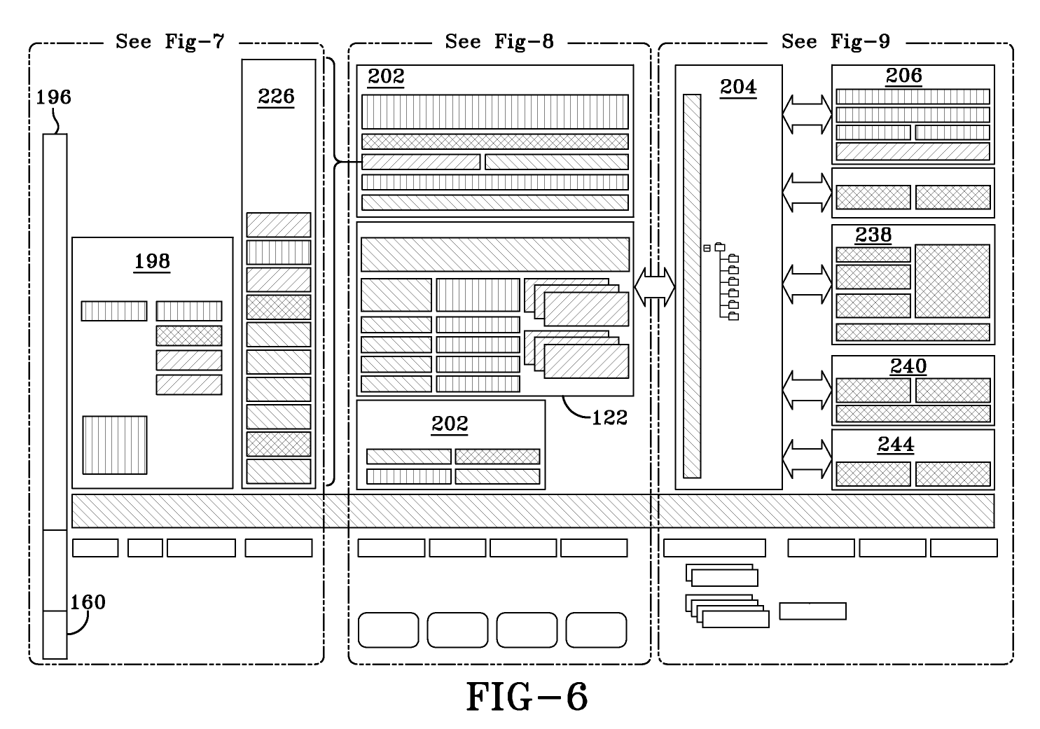

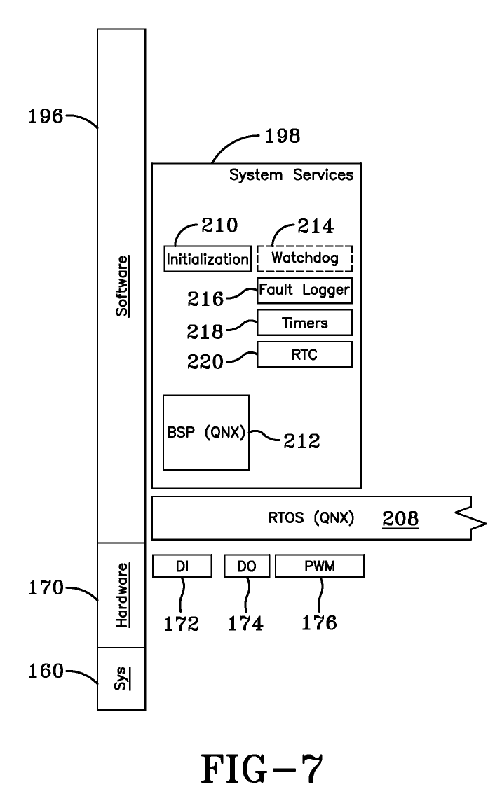

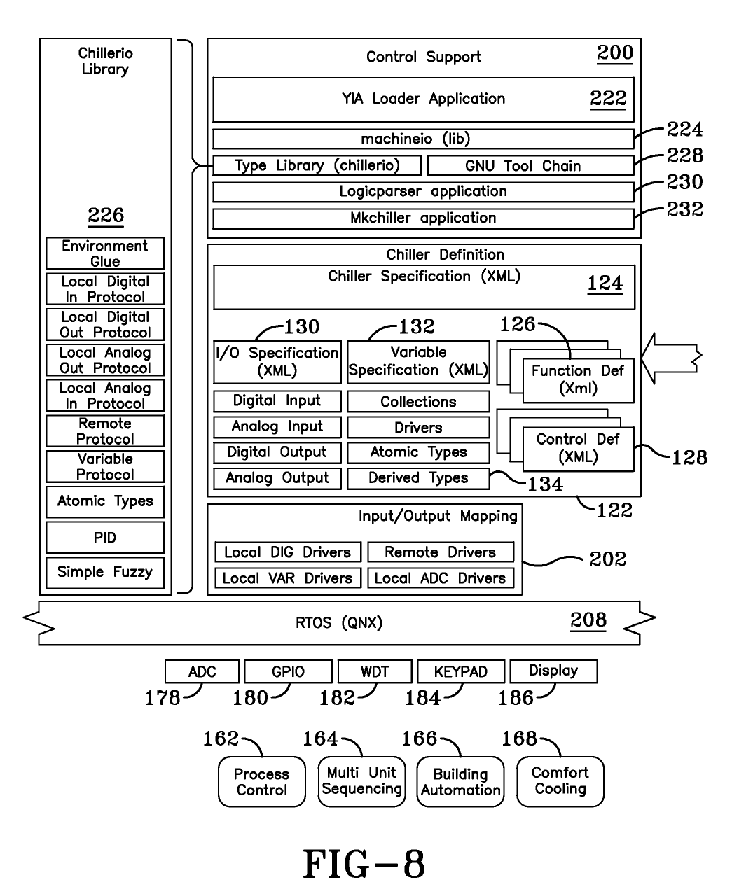

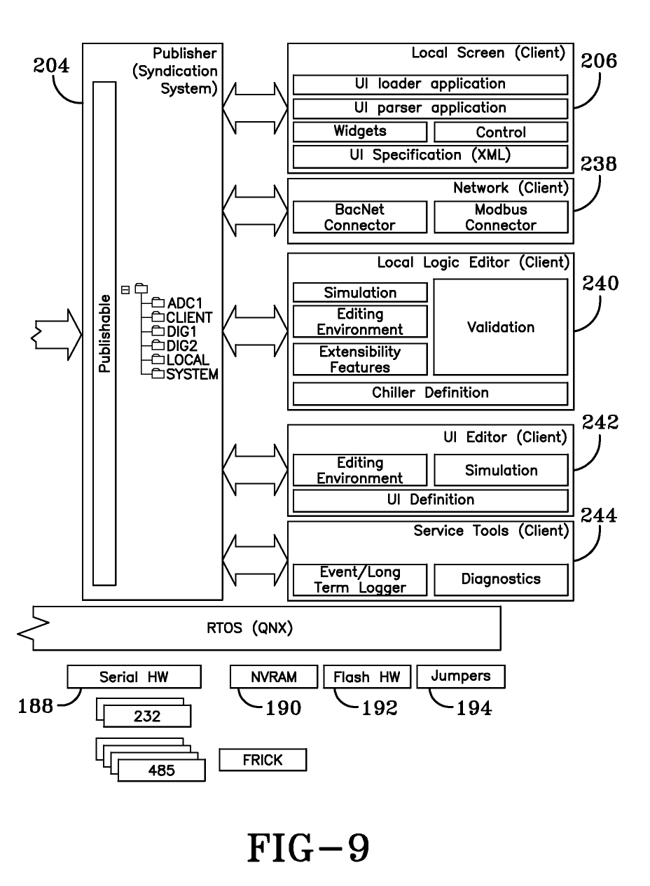

Referring next to FIGS. 6, 7, 8, and 9, the system, hardware and software architecture for the control logic unit is shown. At system level 160, the control system includes process control instructions 162, multiple unit sequencing instructions 164, building automation instructions 166 and comfort cooling controls 168. At hardware level 170, a variety of devices are employed. By way of example, and not limitation, a hardware devices may include digital input (DI) 172, a digital output (DO) 174, a pulse width modulation (PWM) 176, an analog-to-digital (ADC) 178, a general purpose I/O (GPIO) 180, a watchdog device timer (WDT) 182, a keypad 184, a display 186, serial hardware devices 188, non-volatile RAM (NVRAM) 190, flash hardware 192 and jumpers 194.

Next, at software level 196, the system includes system services 198, a control support 200, a chiller definition 122, I/O mapping 202, a publisher or syndication system 204, a local screen 206 and a real-time operating system (RTOS) 208.

System services 198 include, for example, an initialization protocol 210, board support package (BSP) 212 with implementation specific support code for a system PC board that conforms to the operating system such as QNX, a watchdog 214, a fault logger 216, timers 218 and a real time clock (RTC) 220.

Control support 200 includes a YIA loader application 222 and a machine I/O library 224; a type library 226, for example, chiller I/O; a GNU tool chain 228; a logic parser application 230; and make chiller application 232. Chiller system input/output (I/O) library 226 includes environment middleware or “glue”, digital I/O protocols, analog I/O protocols, remote protocol, variable protocol, atomic types, PID and a simple fuzzy logic algorithm.

A chiller definition 122 is included in software environment 196 as previously described. Chiller definition 122 also includes analog and digital I/O modules, collections, drivers and atomic types. I/O mapping 202 includes various drivers for local DIG, VAR and ADC and remote drivers.

Chiller specification 122 is published to local screen 206 by publisher/syndication system 204. Publisher 204 publishes chiller control information to local screen client 206, a network client 238, a local logic editor 240, a User Interface (UI) editor 242 and service tools 244.

Local screen client 206 includes loader and parser applications, control, widgets and UI specification, for example, XML. Network client 238 includes a BACnet connector and a Modbus connector. Local logic editor client 240 includes simulation, editing environment, extensibility features, validation and chiller definition. UI editor 242 has an editing environment, simulation and UI definition. Service tools client 244 includes an event/long term logger and diagnostics.

To reduce latency attributable to loop timing constraints, the binary formatted control logic representation may be configured so that the control logic is invoked only when a set of input conditions change (as contrasted with a polled mechanism that repeatedly queries the control system for status updates.) The control logic encapsulates basic procedural information such as control loops, conditional statements, assignments, invocation of external methods, type definitions and other constructs typically found in a programming language. Portions of the binary formatted representation are contained in external collections of binary code, which may be combined with the control logic to perform a complete set of control logic instructions.

As described above, one embodiment includes the software language representation of the control logic in a human readable format, for example, XML. The software language representation may include an intermediate format to accommodate more efficiently a translation into native machine code. The method may include providing a security feature wherein only a subset of the entire control logic may be modified in the device. The representation of the software language representation of the control logic may also be encrypted. The method may include rendering the logic in a human-readable, graphical format to facilitate modification of the control logic. The method may include automatically modifying the logic based on inputs from the device and ancillary equipment and systems associated with the device to facilitate modification of the control logic. Execution of the control logic may optionally be distributed to multiple microprocessors, or to multiple CPU cores. One or more intermediate representations may be automatically constructed and used as input to tools in a tool sequence that outputs the binary representation. In one embodiment, a front-end tool could generate code that is directly (natively) compiled by the front-end tool. In the front end tool embodiment, no intermediate representation is employed to translate or convert the ladder logic or higher level code. The front end tool embodiment reduces the choices of control at the front end, but is a workable solution. The microprocessor-based control electronics are built into the chiller, including capability for converting a human readable form of the logic into a machine readable form of native code.

A condensed version of a front end tool may be executed directly by the microprocessor-based electronic controller of the chiller system. This condensed front end tool could include less functional capability than a typical IEC 61131-3 compliant tool, but include functionality sufficient to enable appropriate control logic customization at the chiller manufacturing stage, or alternatively, after installation of the chiller in the field. The chiller system may also include a validation code to ensure that field or factory alterations cannot be modified in such a way as to damage the chiller.

In another embodiment of the present application, a front end tool is selected that is capable of generating an XML program that is compliant with relevant standards for machine logic control, such as IED Standard No. 61131-3. An XML representation of the control logic is converted directly into a machine readable code library by conversion software. This conversion software can operate on a host platform, or directly on the chiller platform. Subsequent to converting the control logic to machine readable code library, the code is loaded in the chiller microprocessor. The chiller microprocessor executes the machine readable code library.

Certain capabilities of the unit may be restricted, either due to time, or for safety and security purposes. For example, the intrinsic capability of the unit to convert a human readable form of the control logic into a machine readable form may be restricted to certain access types, or may require an additional piece of software only made available to selected individuals.

Variants of a typical embodiment may incorporate limitations with respect to access privileges to the tool chain when the XML code is converted into machine readable code. For example, in one embodiment of the application the tool chain may be deployed only partially, and access to tools for altering logic may be restricted to selected classes of individuals, for example, certified service personnel, in the form of media that they can load and unload from the unit. The XML standard is more universal but other standards may be employed. XML code represents one particular mechanism of representing the logic that is fairly easy to manipulate programmatically and can accommodate any of the languages that are currently used in the IED Standard No. 61131-3. Other variants of this representation exist or can be developed. As an example, IEC 61131-3 identifies structured text as a language. It could be used as an intermediate representation.

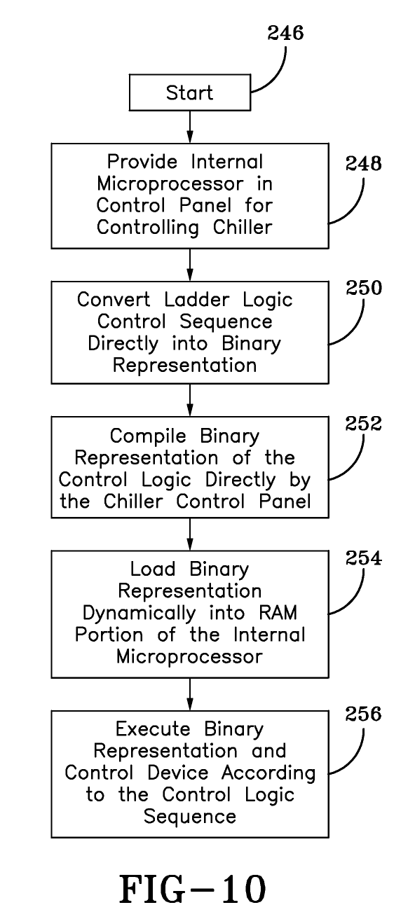

Referring to FIG. 10, a method of executing a control logic sequence for a device, for example, a chiller, begins at step 246 with the system startup. At step 248, there is provided a device mounted internal microprocessor in data communication with the device. At step 250, a software language representation of the control logic sequence is directly converted into a binary representation of the control logic. Next, at step 252, the binary representation of the control logic sequence is compiled directly by an internal microprocessor mounted within the control panel of the chiller. Next, the method proceeds at step 254 to load the binary representation of the control logic sequence dynamically into a random access memory portion of the internal microprocessor. In the next step 256, the binary formatted representation of the control logic sequence is executed, to control the device according to the software language representation of the control logic sequence.

While only certain features and embodiments of the invention have been illustrated and described, many modifications and changes may occur to those skilled in the art (for example, variations in sizes, dimensions, structures, shapes and proportions of the various elements, values of parameters (for example, temperatures, pressures, etc.), mounting arrangements, use of materials, colors, orientations, etc.) without materially departing from the novel teachings and advantages of the subject matter recited in the claims. The order or sequence of any process or method steps may be varied or resequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (for example, those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A method of executing a software language representation of a control logic sequence for a device comprising:
using a device mounted internal microprocessor in data communication with the device, converting the software language representation of the control logic sequence directly into a binary representation of the control logic sequence;
compiling the binary representation of the control logic sequence directly by the device mounted internal microprocessor;
loading the binary representation of the control logic sequence dynamically into a random access memory portion of the internal microprocessor; and
executing the binary formatted representation of the control logic sequence to control the device according to the software language representation of the control logic sequence.

2. The method of claim 1, also including invoking the binary formatted control logic representation only when one or more input conditions of a set of input conditions changes state.

3. The method of claim 1, also including encapsulating one or more sets of basic operational instructions in the control logic sequence.

4. The method of claim 3, wherein the one or more sets of encapsulated basic operational instructions includes control loops, conditional statements, assignments, invocation of external methods; type definitions; and other constructs based on a programming language.

5. The method of claim 4, wherein portions of the binary formatted control logic representation are contained in one or more external collections of binary code, and at least one of the external binary code collections may be combined with the control logic and perform a complete set of control logic instructions for operating the device.

6. The method of claim 1, wherein the software language representation of the control logic is represented in a human readable format

7. The method of claim 6, wherein the human readable format is XML.

8. The method of claim 1, wherein the method also includes translating the software language representation of the control logic into an intermediate format, before converting the software language representation of the control logic sequence directly into a binary representation of the control logic sequence; and translating the intermediate format into a binary representation of the control logic sequence.

9. The method of claim 8, wherein the method also includes automatically constructing at least one intermediate format, inputting the automatically constructed intermediate format into a tool sequence, and producing the binary representation of the control logic.

10. The method of claim 1, wherein the method also includes providing a security feature wherein only a subset of the entire control logic may be modified in the device.

11. The method of claim 1, also including:
encrypting the software language representation of the control logic.

12. The method of claim 1, also including:
representing the device control logic in a human-readable, graphical format.

13. The method of claim 1, also including:
automatically modifying the control logic representation based on inputs from the device and one or more ancillary items of equipment or systems associated with the device.

14. The method of claim 1, also including:
distributing execution of the control logic to multiple microprocessors, or to multiple CPU cores.

15. A system for executing a software language representation of a control logic sequence for a machine, comprising:
a control logic panel having an internal microprocessor mounted on the machine, the microprocessor in data communication with the machine and the control logic panel includes an abstract operating environment having a user interface, an operating system and an engine, the abstract operating environment configured to:
convert the software language representation of the control logic sequence directly into a binary representation of the control logic sequence;
directly compile the binary representation of the control logic sequence directly by the device mounted internal microprocessor;
load the binary representation of the control logic sequence dynamically into a memory portion of the internal microprocessor; and
execute the binary formatted representation of the control logic sequence to control the device according to the software language representation of the control logic sequence.

16. The system of claim 15, wherein the user interface 12 includes a subscriber.

17. The system of claim 16, wherein the subscriber is an abstraction of a client.

18. The system of claim 16, wherein the operating system is selected from a group of operating systems consisting of: QNX®, Microsoft® Windows®, MS Vista®, Linux®, Mac OS®, Unix®, and similar operating systems.

19. The system of claim 16, wherein the subscriber is communicatively coupled to the engine through an interface and operable to query the engine for published items.

20. The system of claim 19, wherein the interface is a Portable Operating System Interface for uniX (POSIX).

21. The system of claim 15, wherein the operating system includes a boot process configured to start or invoke the engine.

22. The system of claim 20, wherein the boot process is configured to provide a machine description file to the engine, the machine description file having an abstraction of the control logic sequence for the machine.

23. The system of claim 21, wherein the engine also includes a main engine process, a publisher, and a parser; the main engine process being configured to execute the machine description file.

24. The system of claim 15, wherein the control logic sequence is abstracted from a compiled environment and converted into a standardized representation independent of the actual code that is executed on the internal microprocessor.

25. The system of claim 15, the software language representation of the control logic sequence is a graphic control programming language software.

26. The system of claim 22, wherein the main engine process invokes the parser using the machine description file.

27. The system of claim 23, wherein the parser is an abstraction of a system that is configured to parsing a stream or file representing the control logic sequence, wherein the parser is configured to define variables and initialize libraries; check for the presence of an element file; find and returns a plurality of elements defined within the element file; return at least one element, or return a message that indicates no elements are returnable.

28. The system of claim 23, wherein the publisher is configured to make visible to other system components information about at least one of the state and variables of the system.

29. The system of claim 23, wherein the publisher is configured to initialize libraries and at least one local variable, accept and validate at least one publishable item, and format the publishable items in a list.

30. The system of claim 19 wherein the interface is configured to format a plurality of data requests from the subscriber and proxy the plurality of data requests to the publisher.

31. A chiller system comprising:
a compressor, a condenser, and an evaporator connected in a closed refrigerant circuit;
the compressor comprising:
a control logic panel having an internal microprocessor mounted on the chiller system, the microprocessor in data communication with the chiller system and configured to:
convert a software language representation of a control logic sequence directly into a binary representation of the control logic sequence;
directly compile the binary representation of the control logic sequence directly by the chiller mounted internal microprocessor;
load the binary representation of the control logic sequence dynamically into a random access memory portion of the internal microprocessor; and
execute the binary formatted representation of the control logic sequence to control the chiller system according to the software language representation of the control logic sequence.
